(19) United States
(12) Patent Application Publication
(10) Pub. No.: US 2018/0321659 A1
(43) Pub. Date: Nov. 8, 2018

(54) SYSTEMS AND METHODS FOR OPTIMIZATION OF 3-D PRINTED OBJECTS

(71) Applicant: SABIC GLOBAL TECHNOLOGIES B.V., Bergen op Zoom (NL)

(72) Inventors: Prasad Dasappa, Bangalore (IN); Gurunath Pozhal Vengu, Bangalore (IN); Aravinda Agarwal, Bangalore, Karnataka (IN); Gerould Harding, Houston, TX (US); Kim Loan Thi Ly, Houston, TX (US)

(21) Appl. No.: 15/773,235

(22) PCT Filed: Nov. 5, 2016
(86) PCT No.: PCT/IB2016/056664

§ 371 Date: May 3, 2018

Related U.S. Application Data
(60) Provisional application No. 62/251,763, filed on Nov. 6, 2015.

(51) Int. Cl. G05B 19/4099; B29C 64/386; B33Y 50/00

(52) U.S. Cl. CPC G05B 19/4099; G05B 2219/35134; B33Y 50/00; B29C 64/386

(57) ABSTRACT

The present subject matter includes systems, methods, and devices for optimization of objects generated using 3-D printing. A printed object may be optimized for performance, such as increasing the strength of the object while retaining the shape of the object. For example, if the object is an object designed for a three-point bend, optimization may include removing material from regions within the object to change the relative densities and stiffness in each of the regions while retaining the original shape of the object. Optimization of an object while retaining the object shape enables the object to function and to appear as it was origin ally designed, and to continue to interact with neighboring components in the same way.

### BACKGROUND

Additive manufacturing, or three-dimensional (3-D) printing, is a production technology for making a solid object from a digital model (e.g., digital object design). 3-D printing processes offer many advantages, including potentially reducing the time between the design phase, the prototyping phase, and the commercialization phase. Design changes can be made throughout the development process based on a physical prototype, which may be more efficient than design changes based on only a digital model or based on a prototype made from an expensive production tool. Generally, no specialized tooling is required because a single type of extrusion head in an additive manufacturing system can be used to create composite shapes of many different sizes and configurations. In some examples, additive manufacturing can reduce the inventory of one or more components. Using additive manufacturing, some objects can be quickly made on-demand and on-site.

Various steps are involved in making a solid object from a digital model. Generally, computer-aided design (CAD) modeling software is used to create the digital model of a desired solid object. Instructions for an additive manufacturing system are then created based on the digital model, for example by virtually “slicing” the digital model into cross-sections or layers. The layers can be formed or deposited in a sequential process by an additive manufacturing device to create the object. Conventional 3-D printing implementations use a consistent printing structure for each layer, and alter the shape of each printed layer to match the digital model as closely as possible.

In contrast to the consistent layer structure used in 3-D printing, graded materials provide a gradually varying structure. Some naturally occurring examples of graded materials include palm trees, bone, or concrete. The gradually varying structure may result in a gradually varying elastic modulus (e.g., stiffness, rigidity) or other gradually varying physical property. Existing 3-D printing techniques do not accurately determine or recreate the gradually varying structures found in naturally occurring graded materials.

### OVERVIEW

The present subject matter includes systems, methods, and devices for optimization of objects generated using 3-D printing. 3-D printing, also referred to as additive manufacturing, additive printing, fused deposition modeling, or direct digital printing, can be used for prototyping or manufacturing using a range of different materials. The present subject matter provides, among other things, a technical solution for determining and implementing an optimized 3-D printing design based on digital model specifications. As used herein, “optimization” of an object refers to generating a 3-D printing digital model based on digital model specifications (e.g., 3-D shape) and at least one defined design architecture constraint. As use herein, a defined design architecture “constraint” refers to any design constraint or other desired design property, where the value of the design constraint may prescribe a boundary or may refer to an approximate goal value, such as a weight, stiffness, strength, or another design property. In some embodiments, the design constraint may be to reduce the weight of or improve the material distribution for a selected digital model. In some embodiments, the design constraint may be to obtain the material distribution for a selected digital model while adhering to a given design criteria, such as a displacement of less than 1 mm.

A design for a printed object (e.g., printed part) may be optimized for performance, such as increasing the strength of the object while retaining the weight and shape of the object. In some examples, if the object is an assembly part designed for a three-point bend, optimization may include removing material to change the relative densities and stiffness in each of the regions while retaining the original shape of the part. Optimization of an object while retaining the object shape enables the object to function and to appear as it was originally designed, and to continue to interact with neighboring components in the same way. In contrast with optimization of an object through redesigning the object, this is optimization of a real object.

This overview is intended to provide an overview of subject matter of the present patent application. It is not intended to provide an exclusive or exhaustive explanation of the invention. The detailed description is included to provide further information about the present patent application.

### BRIEF DESCRIPTION OF THE DRAWINGS

In the drawings, which are not necessarily drawn to scale, like numerals may describe similar components in different views. Like numerals having different letter suffixes may represent different instances of similar components. The drawings illustrate generally, by way of example, but not by way of limitation, various embodiments discussed in the present document.

FIGS. 1A-1B are block diagrams of an example of a cantilever beam design.

FIG. 2 is a block diagram of an example compounding system.

FIGS. 3A-3C are block diagrams of examples of printing directions.

FIGS. 4A-4B are block diagrams of an example of region-specific printing directions.

FIGS. 5A-5B are block diagrams of an example of region-specific shaped printing directions.

FIGS. 6A-6B are perspective views of an example of a printed honeycomb structure.

FIG. 7 is a perspective view of an example of a transversely separated structure.

FIG. 8 is a perspective view of a hybrid additive manufactured part.

FIG. 9 is a block diagram of planar Hybrid Additive Manufacturing.

FIG. 10 is a block diagram of non-planar Hybrid Additive Manufacturing.

FIG. 11 is a block diagram of non-planar Hybrid Additive Manufacturing with pre-formed laminates.

FIG. 12 is a block diagram of non-planar moveable Hybrid Additive Manufacturing with pre-formed laminates.

FIGS. 13A-13D are block diagrams of Hybrid Additive Manufacturing using fixtures.

FIGS. 14A-14B are block diagrams of 3-D printing with ATP/laminates.

### DETAILED DESCRIPTION

This detailed description includes references to the accompanying drawings, which form a part of the detailed description. The drawings show, by way of illustration, specific embodiments in which the invention can be practiced. These embodiments are also referred to herein as “examples.” Such examples can include elements in addition to those shown or described. However, the present inventor also contemplates examples in which only those elements shown or described are provided. Moreover, the present inventor also contemplates examples using any combination or permutation of the elements shown or described (or one or more aspects thereof), either with respect to a particular example (or one or more aspects thereof), or with respect to other examples (or one or more aspects thereof) shown or described herein.

In this document, the terms “a” or “an” are used, as is common in patent documents, to include one or more than one, independent of any other instances or usages of “at least one” or “one or more.” In this document, the term “or” is used to refer to a nonexclusive or, such that “A or B” includes “A but not B,” “B but not A,” and “A and B,” unless otherwise indicated. In this document, the terms “including” and “in which” are used as the plain-English equivalents of the respective terms “comprising” and “wherein.” Also, in the following claims, the terms “including” and “comprising” are open-ended, that is, a system, device, article, composition, formulation, or process that includes elements in addition to those listed after such a term in a claim are still deemed to fall within the scope of that claim. Moreover, in the claims, the terms “first,” “second,” and “third,” etc. are used merely as labels, and are not intended to impose numerical requirements on their objects.

Systems, devices, and methods according to the present disclosure are configured primarily for use in additive manufacturing (AM), also referred to as material extrusion additive manufacturing, deposition modeling, or 3-D printing. Without limiting the scope of the present disclosure, systems for additive manufacturing can include stand-alone manufacturing or printing units, a series of units on an assembly line, or a high volume system for additive manufacturing that includes one or more workflow automation features such as a conveyor for transporting parts to or from a build area, or a robot arm for transporting parts or adjusting a system component.

Additive manufacturing systems can include, among others, systems configured to perform fused deposition modeling (FDM). FDM is an additive process in which layers of material are successively deposited and fused together to form an object composite. Materials suitable for FDM include production-grade thermoplastics such as ABS, polycarbonate (PC), and polyetherimide (PEI), among others. Support material used in FDM can optionally be water based. Polyjet is an additive process that uses a UV-cured photopolymer resin that can be deposited using a print head. In Selective Laser Sintering, or SLS, powdered polymer, metal or ceramic materials can be deposited and cured, such as using a laser to melt a surface of a powered material. Some materials suitable for SLS processes include nylon, titanium, and brass. In Multijet Modeling (MJM), a microscopic layer of resin is deposited on a support made of wax, and the wax can be melted away from the object composite. In Stereolithography, a laser can be used to cure a deposited resin material. These additive manufacturing systems and others can be improved by employing the systems and methods described herein.

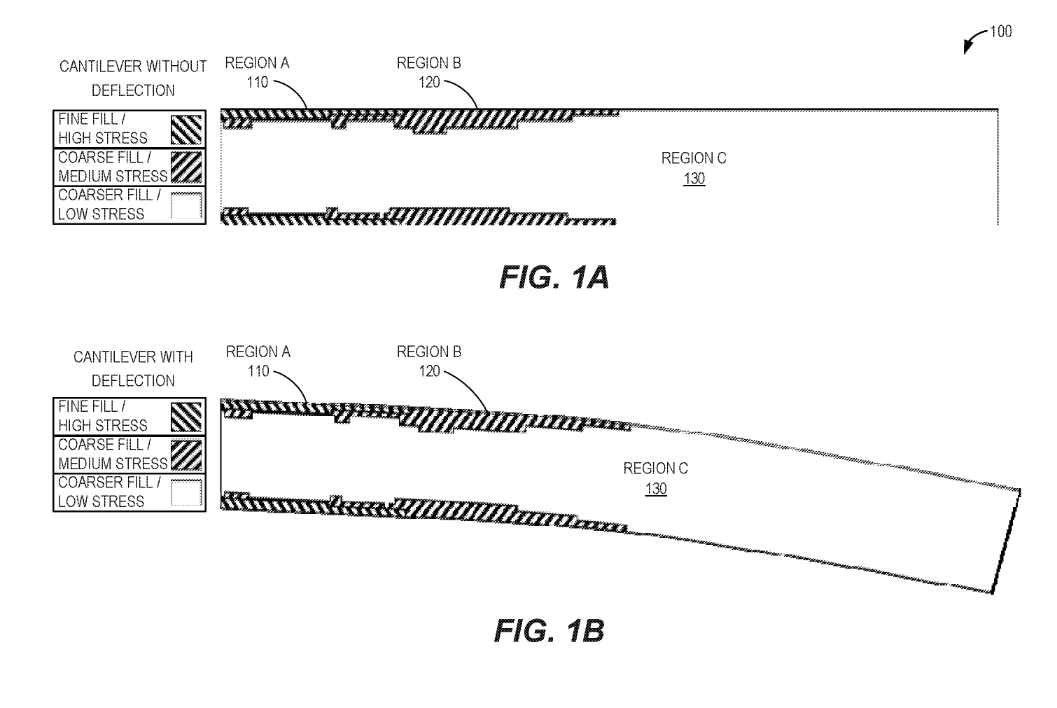

FIGS. 1A-1B are block diagrams of an example of a cantilever beam design 100. FIG. 1A shows a cantilever beam design without deflection, and FIG. 1B shows a deflected cantilever beam design. The deflection may be provided as a design deflection constraint, such as an indication that the beam is expected to receive a particular force at the end of the beam, or that the beam end is expected to deflect by a particular distance. Design constraints may also include operational constraints, such as and expected operational environment temperature, an expected operational environment humidity, or other operational constraints. Though a cantilever beam design is shown in FIGS. 1A-1B, other design structures and other design constraints may be used.

The beams in FIGS. 1A-1B are separated into three regions: Region A 110, Region B 120, and Region C 130. Each of these regions may correspond to regions that exhibit various values of stresses under the applied load. For example, applying a load and deflecting an end of cantilever beam design 100 may result in high stress in Region A 110, medium stress in Region B 120, and low stress in Region C 130. Materials of various properties may be used to correspond to each of these stress regions such as materials with varying stiffness (e.g., elastic modulus, rigidity) or yield strength (e.g., yield stress). For example, a fine fill may be used for the high stress Region A 110, a coarse fill may be used for medium stress Region B 120, and a coarser fill may be used in low stress Region C 130. The properties of each region may be provided as design constraints, or the regions may be determined based on the digital model specification (design shape) and one or more design constraints. An example of a material with varying stiffness and yield strength of these regions is shown in Table 1 below:

TABLE 1
Region Stiffness and Yield Strength

| | Stiffness | Yield |
|---|---|---|
| | (Elastic Modulus) | Strength |
| Region | (MPa) | (MPa) |
| Region A | 10000 | 60 |
| Region B | 5000 | 40 |
| Region C | 2000 | 20 |

Various regions can use materials with varying stiffness or yield strength within a digital model to generate an optimized printable digital model. In some examples, multiple materials with independently varying stiffness and yield strength can be used, such as increasing stiffness while decreasing yield strength or decreasing stiffness while increasing yield strength. In some examples, an optimized printable digital model includes a combination of multiple, dissimilar printing materials or printing densities. The regions of differing printing materials or densities are selected to result in desired characteristics for the resulting printed object, such as stiffness, strength, or other characteristics. Though FIGS. 1A-1B show three regions, additional printing regions may be generated to implement a gradually varying structure, such as to provide the advantages of gradually varying structures found in naturally occurring graded materials.

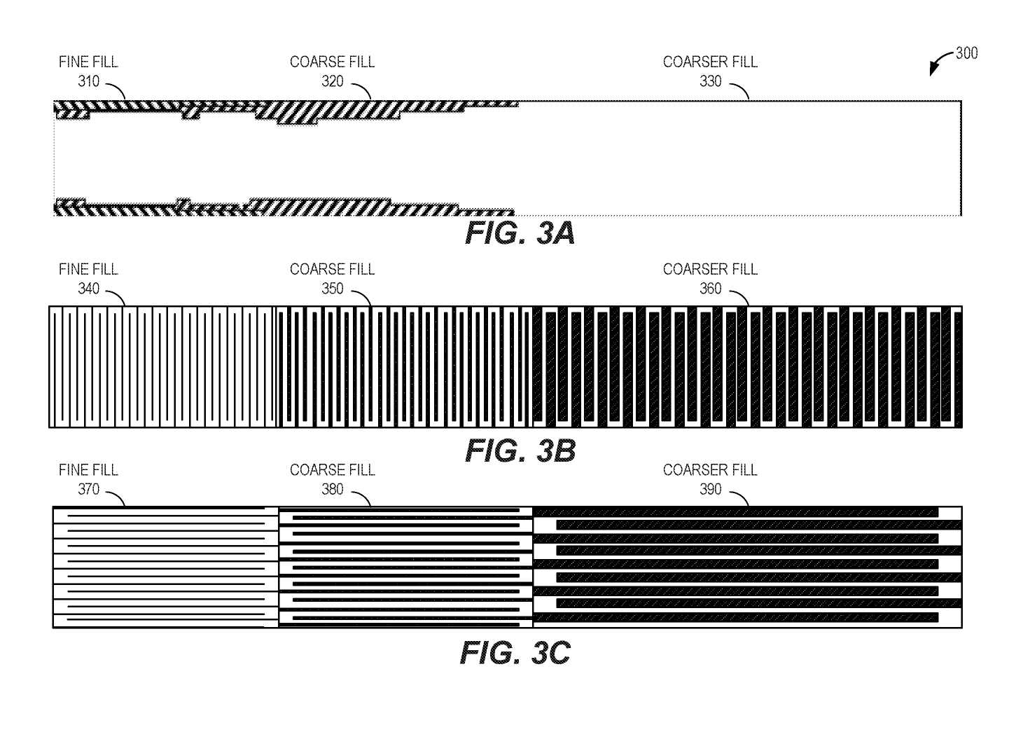

The regions of differing printing densities may be implemented by varying a printing composite material, by varying a printing pattern, by using dissimilar materials, by varying other printing variables, and by various combinations thereof. A printing density may be selected to correspond to each of these regions of various stress levels within the cantilever beam. In some examples, three printing densities may be used, such as including a fine fill, a course fill, and coarser fill. For example, a fine fill may be used in high-stress Region A 110, a coarse fill may be used in medium-stress Region B 120, and a coarser fill may be used in low-stress Region C 130. The physical characteristics of the fine, coarse, and coarser fills may be defined absolutely or relative to each other. In some examples, the varying fill printing densities may be used in locations corresponding to the varying stress regions, such as shown in FIGS. 1A-1B. In other examples, the printing regions may be organized differently from the materials with varying stiffness or yield strength, such as shown in FIGS. 3A-3C.

A printed object may include a combination of an outer surface (e.g., skin) and an in-fill (e.g., printing pattern density) within the printed object, where the outer surface conforms to the shape of the original part design. A desired printing density may be implemented by varying the outer surface thickness or by varying the amount of in-fill used within the printed object. In some examples, a 3-D printer applies filaments to a layer in a linear printing pattern. Increasing the distance between adjacent printed filaments may reduce the amount of filament material required and may provide for faster printing. Reducing in-fill density reduces the weight of a device, but also reduces its strength and rigidity. The in-fill density therefore needs to be selected carefully according to the weight, strength, and rigidity requirements of the desired object to be generated.

A fiber composite material may be used to reduce device weight while maintaining strength and rigidity. The type, size, shape, and percentage of fiber may be varied to achieve desired fiber composite characteristics. In some examples, various carbon-fiber percentages may be used in each region, such as shown in Table 2 below:

TABLE 2
Region Carbon-Fiber Content

| Region | Fiber (%) |
|---|---|
| Region A | 30 |
| Region B | 15 |
| Region C | 0 |

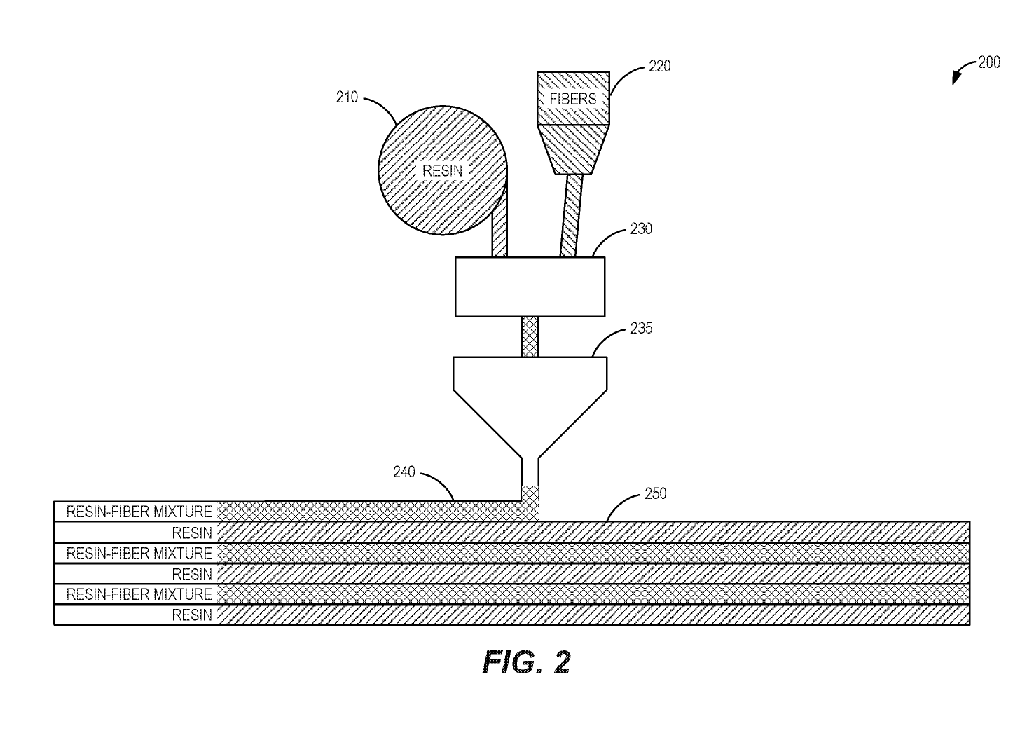

While Table 2 shows specific carbon-fiber percentages for each region, other examples may use gradually varying carbon-fiber percentages. In some examples, the carbon-fiber is provided in the form of cylindrical carbon-fiber filaments ranging from a few millimeters to a few centimeters in length, though other carbon-fiber shapes or lengths may be used. The carbon-fiber filament type or percentage may be implemented using a compounding system shown in FIG. 2.

FIG. 2 is a block diagram of an example compounding system 200. The in-nozzle compounding system 200 may be used for 3-D printing of functionally graded composites. In some examples, a gradually varying stiffness may be achieved by determining the composition of a composite printing material. For example, a fiber-reinforced polymer may include a binding polymer matrix 210 such as an amorphous polycarbonate polymer (such as Ultem™ and Lexan™ manufactured by SABIC), a thermoset polymer, or other another polymer. The fiber-reinforced polymer may also include fiber reinforcement 220, such as inorganic fibers (e.g., glass fibers), organic fibers (e.g., carbon fibers), or metallic fibers (e.g., aluminum fibers). The materials and relative proportions for the polymer matrix and fiber reinforcement may be determined to provide a desired strength and rigidity for each printed layer or for a group of printed layers.

In some examples, a compounder 230 may use a differential motion to combine the binding polymer matrix 210 and the fiber reinforcement 220, and feed the combination to a nozzle 235. In other examples, the nozzle 235 may provide in-nozzle compounding of the binding polymer matrix 210 and the fiber reinforcement 220. A 3-D object may be created using a 3-D printer to determine and extrude filaments or layers of the composite material to form the 3-D object. In some examples, the resulting composite printing material may include a resin-fiber mixture layer 240 of varying levels of fiber reinforcement 220, which may be used to print an object of gradually varying rigidity. In some examples, an object may be printed using any combination of one or more a resin-fiber mixture layers 240 or resin layers 250.

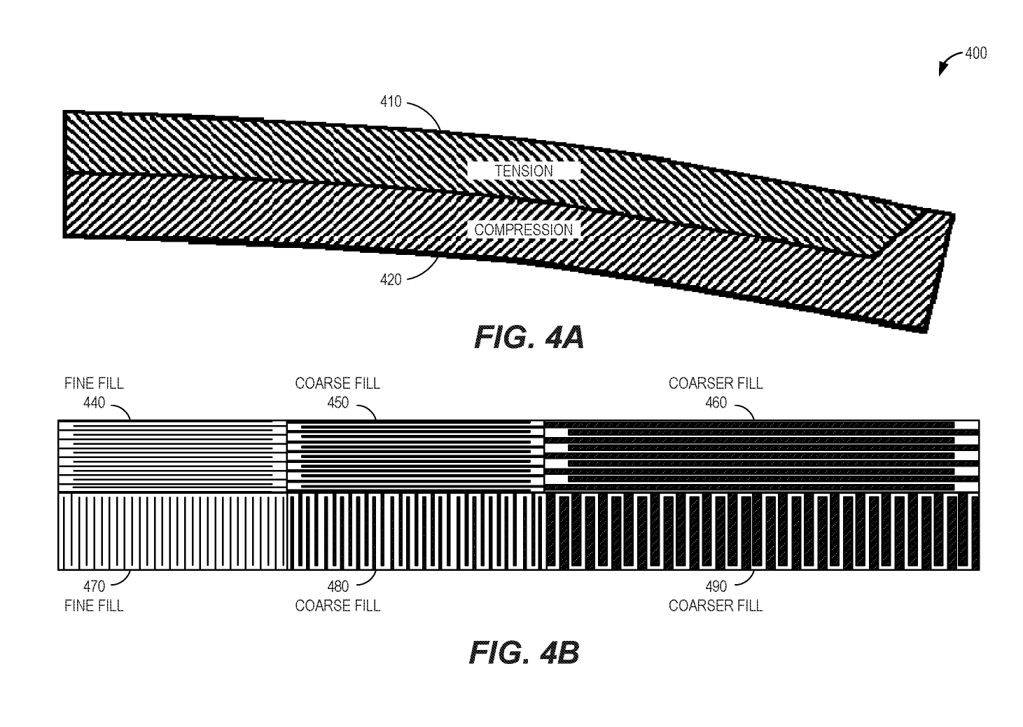

FIGS. 3A-3C are block diagrams of examples of printing directions 300. FIGS. 3A-3C show examples of optimization of the fills used in 3-D printing, such as may be used to lower weight or increase performance (e.g., stiffness, strength). FIG. 3A shows an example use of a fine fill 310, a coarse fill 320, and a coarser fill 330, where the various fills are used in locations corresponding to the high, medium, and low stress regions respectively to increase stiffness or yield strength, such as shown in FIGS. 1A-1B. In other examples, various portions of the in-fill within a beam may be separated into areas of parallel and perpendicular printing. In examples shown in FIGS. 3B-3C, a rectangular beam may be printed, and the filament may be printed parallel or perpendicular to the longest edge of the beam. FIG. 3B shows a beam printed using a vertical printing pattern that includes a fine vertical fill 340, a coarse vertical fill 350, and a coarser vertical fill 360 corresponding to high, medium, and low stress regions shown in FIG. 1. Similarly, FIG. 3C shows a beam printed using a horizontal printing pattern that includes a fine horizontal fill 340, a coarse horizontal fill 350, and a coarser horizontal fill 360 corresponding to high, medium, and low stress regions shown in FIG. 1. A vertical or horizontal fill pattern may be modified according to an expected contraction (e.g., shrinkage) or expansion associated with printing using a selected fill material. For example, a printed bead route may be selected to compensate for expected contraction associated with a carbon fiber resin. In some examples, a combination of vertical and horizontal fill patterns would provide structural advantages, such as shown in FIG. 4B.

FIGS. 4A-4B are block diagrams of an example of region-specific printing directions 400. In some examples, an optimization of printing includes optimizing distribution with printing aligned with a stress region, a stress type, or a stress magnitude. A desired structural characteristic may be determined for each region or sub-region, and the structural characteristic may be used to determine printing parameters. The printing parameters may include a printing direction, a printing density distribution (e.g., spacing between adjacent filaments), or a proportion of polymer matrix and fiber reinforcement.

In some examples, optimization may include separation of tension and compression regions, where each tension or compression region may be subdivided into subregions of higher and lower tension or compression stress. FIG. 4A shows a deflected cantilevered beam, including a tension region 410 and a compression region 420. Within a beam deflected as shown in FIG. 4A, a horizontal (e.g., longitudinal) printing pattern may be more resistive to tension, and a vertical (e.g., lateral) printing pattern may be more resistive to compression. The tension region 410 and the compression region 420 may be subdivided into two or more subregions. In the upper region of the beam corresponding approximately to tension region 410, a fine horizontal fill 440 may be used in a region of highest tensile stress, a coarse horizontal fill 450 may be used in a region of lower tensile stress, and a coarser horizontal fill 460 may be used in a region of lowest tensile stress. Similarly, in the lower region of the beam corresponding approximately to compression region 420, a fine vertical fill 470 may be used in a region of high compressive stress, a coarse vertical fill 480 may be used in a region of lower compressive stress, and a coarser vertical fill 490 may be used in a region of lowest compressive stress.

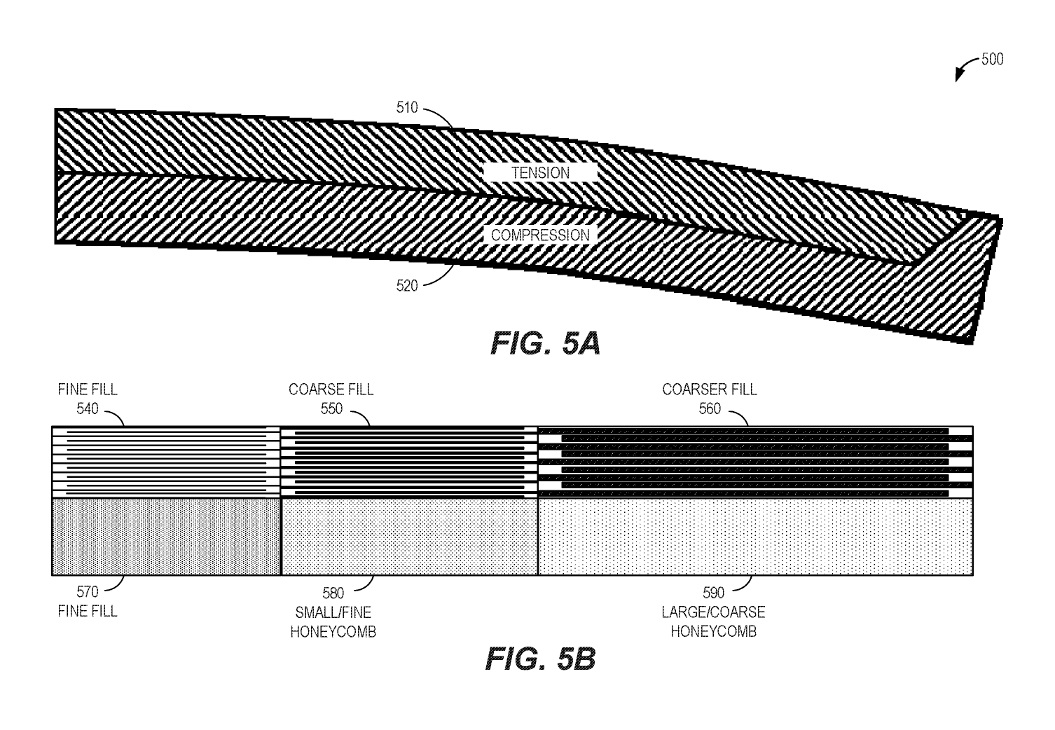

In some examples, the locations of the horizontal and vertical fill patterns may be selected to balance printing and material efficiency, such as printing coarser horizontal fill 460 in a location that includes a both tension and compression regions. In other examples, the locations of the horizontal and vertical fill patterns may correspond closely or exactly to regions of tension and compression. In further examples, an optimization of printing includes selection of nonlinear printing fill patterns to reduce weight and increase performance, such as shown in FIG. 5B.

FIGS. 5A-5B are block diagrams of an example of region-specific shaped printing directions 500. Within existing 3-D printing algorithms, it may be difficult to obtain or generate data for compression in linear printing region using a coarser fill. Additional printing techniques or structures may be used to vary the strength and rigidity for one or more regions within a printed object. In some examples, the filament may be printed in a nonlinear cross-section structure, such as a honeycomb cross-section. A honeycomb cross-section structure may be used to provide strength, such as in a compression region. Other printing structures may be used, such as various polygons, truss structures, or other structures. In addition to structure selection and printing direction, the printing density may be selected to achieve a desired strength and rigidity. The printing structure printed density may also be selected according to an expected contraction (e.g., shrinkage) or expansion associated with printing using a selected fill material. For example, a printed structure bead route may be selected to compensate for expected contraction associated with a carbon fiber resin.

In some examples, a honeycomb structure may be used, as honeycomb structures are particularly effective when loaded in compression. As shown in FIG. 5A, the deflected cantilevered beam includes a tension region 510 and a compression region 520. As shown in FIG. 5B, a linear pattern could be printed in the tension region 510, and compression regions 520 could include honeycomb structure. In the upper region of the beam corresponding approximately to tension region 510, a fine horizontal fill 540 may be used in a region of highest tensile stress, a coarse horizontal fill 550 may be used in a region of lower tensile stress, and a coarser horizontal fill 560 may be used in a region of lowest tensile stress. However, in the lower region of the beam corresponding approximately to compression region 520, a fine honeycomb fill 570 may be used in a region of high stress, a small honeycomb fill 580 may be used in a region of low stress, and a large honeycomb fill 590 may be used in a region of lower stress. The size, distribution, and other characteristics of the honeycomb structure can be determined algorithmically.

In addition to identification of compression and tension regions, an optimization of printing includes printing a fine fill in a load path region. For example, if the object is an assembly part designed for a three-point bending test, a load path region may be identified between the three points, and a fine linear or nonlinear fill may be used in the load path region.

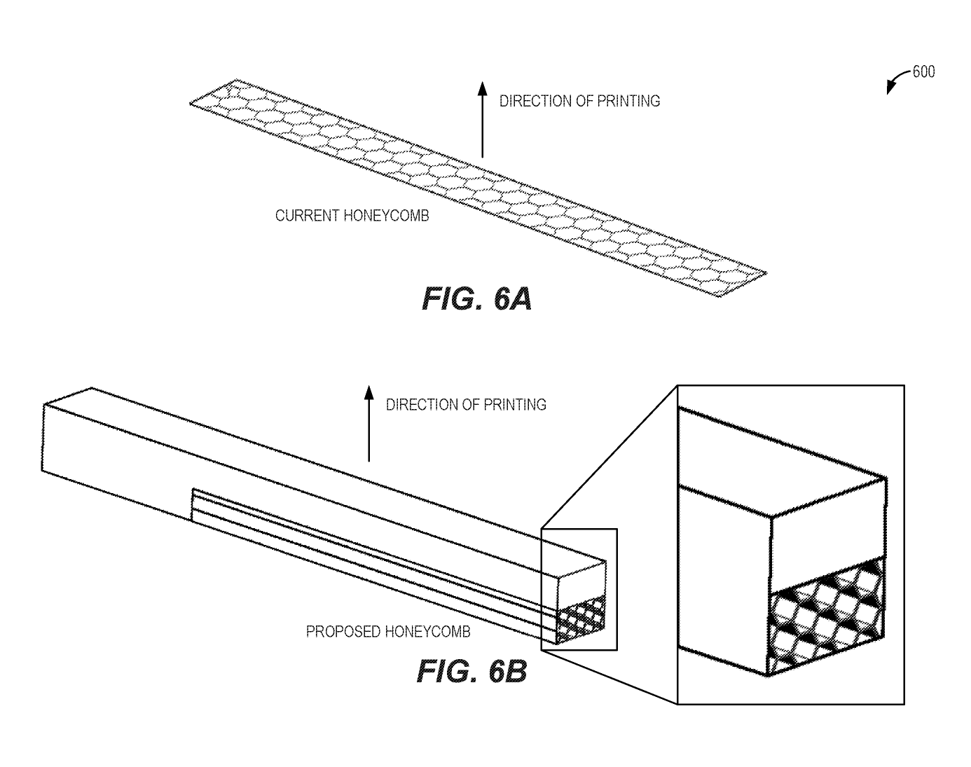

FIGS. 6A-6B are perspective views of an example of a printed honeycomb structure 600. In some embodiments, a tubular structure (e.g., honeycomb, circle, oval, closed polygon) is used for weight reduction. For example, a honeycomb structure may be used, as a honeycomb structure is sparser and more resistive to compressive stresses than a linear printing structure. In existing 3-D printing, the direction of printing is often selected based on convenience of printing, and not based on performance. A honeycomb structure is typically aligned in the direction of printing, such as shown in FIG. 6A.

FIG. 6B shows the printing direction as perpendicular to the honeycomb structure. Unlike typical 3-D printing techniques, the proposed the direction is not selected for printing convenience, but instead is selected based on performance of the part or performance of the printing. For example, the printing direction could be selected to improve manufacturing throughput by improving printing speed. A combination of ease of printing and performance may be selected. In selecting the printing direction to improve printing performance or the structural performance of the printed part, the printing may or may not be aligned in the direction of printing. FIG. 6B shows the printing direction as perpendicular to the honeycomb structure, though the proposed honeycomb configuration shown in FIG. 6B is not limited to printing direction. The part may be aligned in a different manner yet the honeycomb may be printed, such supporting the part horizontally in order to print the part vertically.

FIG. 6B shows a cutaway view of a beam printed with an outer surface and an inner honeycomb structure. As shown in FIG. 6B, the honeycomb structure may be printed in a compression region in the direction of minimum principal stresses (or the peak of the absolute principal stress values). A single region with a single average direction may be used, or various regions may use different printing directions. In some examples, variation of direction of minimum principal stress may be high, and the printing direction may be selected to correspond to a direction based on compatibility with regions with peak compressive stress, based on 3-D printer capabilities, or based on other considerations. Such a structure may provide resistance to compressive forces in the compression region while reducing the weight of the printed part.

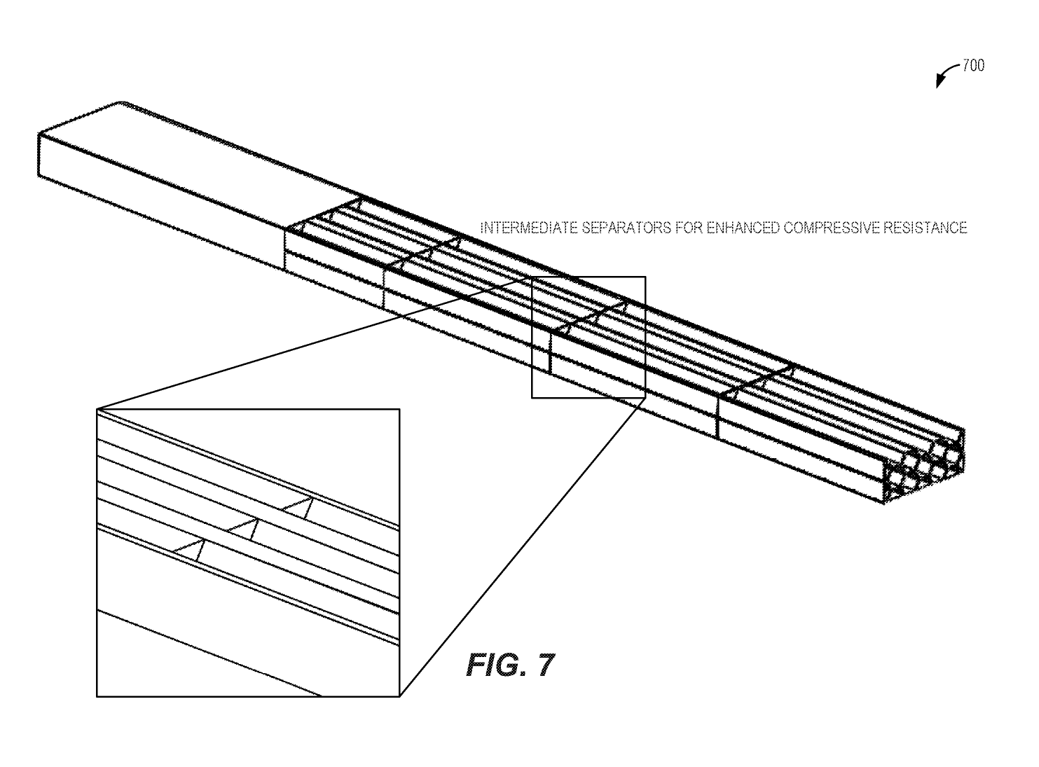

FIG. 7 is a perspective view of an example of a transversely separated structure 700. While some structures provide reduced weight and increased strength when loaded in compression, longer structures may result in some reduced strength. To counteract the reduced strength of longer structures, these longer structures may include transverse separators at selected locations to increase strength, such as shown in FIG. 7. In other embodiments, this reduced strength may be addressed by using a gradual change in cross-section shape or shape size. For example, the size of individual cells within a honeycomb structure may be reduced throughout the length of the structure. In another example, the cross-sectional shape may be changed gradually, such as gradually changing from a honeycomb cross-section to a circular cross-section. A combination of transverse separators and gradually changing shapes may be used to separate various regions of tension or various regions of compression.

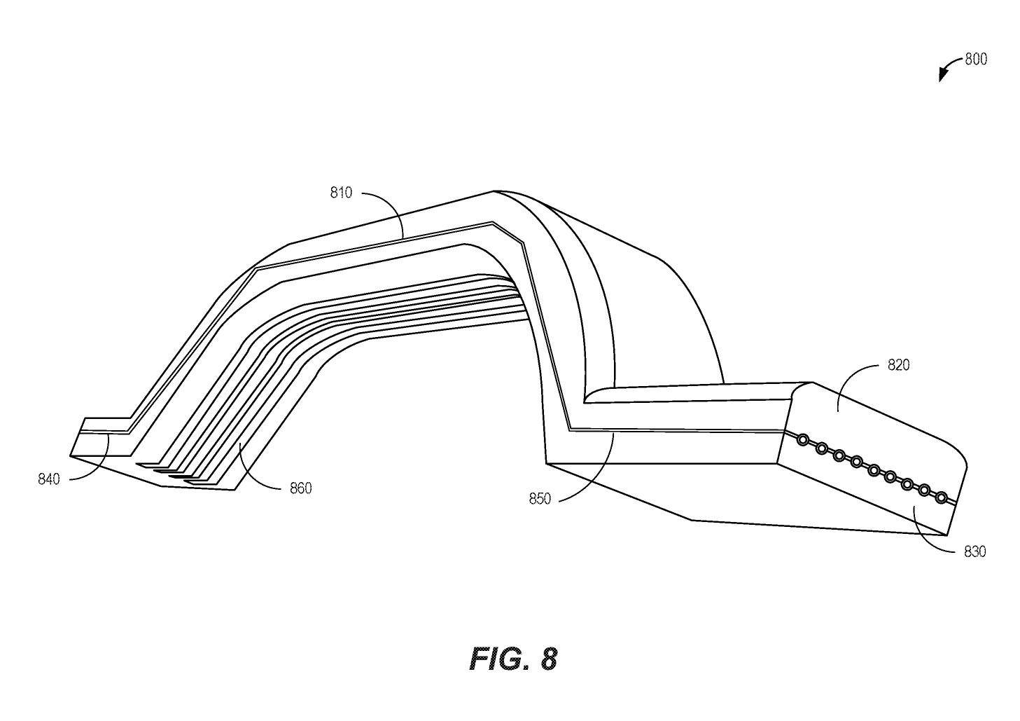

FIG. 8 is a perspective view of a hybrid additive manufactured part 800. Hybrid Additive Manufacturing may include a combination of Automatic Tape Placement (ATP) and Additive Manufacturing (e.g., 3-D printing). There are limitations to existing 3-D printing using fused deposition modeling (FDM), such as limitations on mechanical performance or speed. As described above, the effect of these limitations may be reduced through the use of fiber-reinforced resin materials, such as using continuous or chopped fiber composites. The fiber material may include inorganic fibers (e.g., glass fibers), organic fibers (e.g., carbon fibers), or metallic fibers (e.g., aluminum fibers). Hybrid Additive Manufacturing augments 3-D printing with composite tapes or composite laminates, and provides additional mechanical performance or speed gains over existing 3-D printing techniques.

In combining ATP with Additive Manufacturing in Hybrid Additive Manufacturing, several changes have been made to existing ATP and Additive Manufacturing techniques. For example, existing ATP solutions may be expanded to provide adhesive on both sides of the laminate, thereby increasing adhesion between multiple layers of laminate and resin. Additionally, Hybrid Additive Manufacturing extends ATP equipment hardware and software, for example to avoid wrinkles when placing laminate or tape.

Some existing 3-D printing techniques may be used in the manufacture of large parts, such as in large format printing or Big Area Additive Manufacturing (BAAM). BAAM offers several advantages, including production of large sized parts or filament-less printing. BAAM may be used to increase production throughput for larger objects, and may improve material selection through introduction of pellet fed material extrusion. In contrast with using existing 3-D printing to print and combine multiple smaller parts into a larger format part, BAAM offers improved print speeds for large format parts. Some disadvantages of BAAM include warping, part integrity (e.g., sagging of the part), performance of the part, and surface finish. Hybrid Additive Manufacturing may improve integrity and reduce warping in BAAM, and may enhance the printing of large or complex parts. For example, Hybrid Additive Manufacturing enables production of customized shapes of reinforced plastics, improves speed and production accuracy, and enables selective reinforcements (e.g., using tapes, fabrics, woven mats, or other materials).

As shown in FIG. 8, one or more reinforcements 810 may be placed throughout the part, such as in regions of higher tensile stress. Reinforcements 810 may be in the form of ATP or laminate placement. The ATP may use a fiber-based tape, where various fiber lengths may be selected to reinforce the tape. The reinforcement 810 may be placed between a top portion 820 and a bottom portion 830 of the part. Reinforcements 810 may be throughout the part, or may be only in selected portions, such horizontal local reinforcement portion 840 or horizontal local reinforcement portion 850. In addition to the reinforcements 810, the part may include additional interior structures 860, such as to improve rigidity or reduce weight.

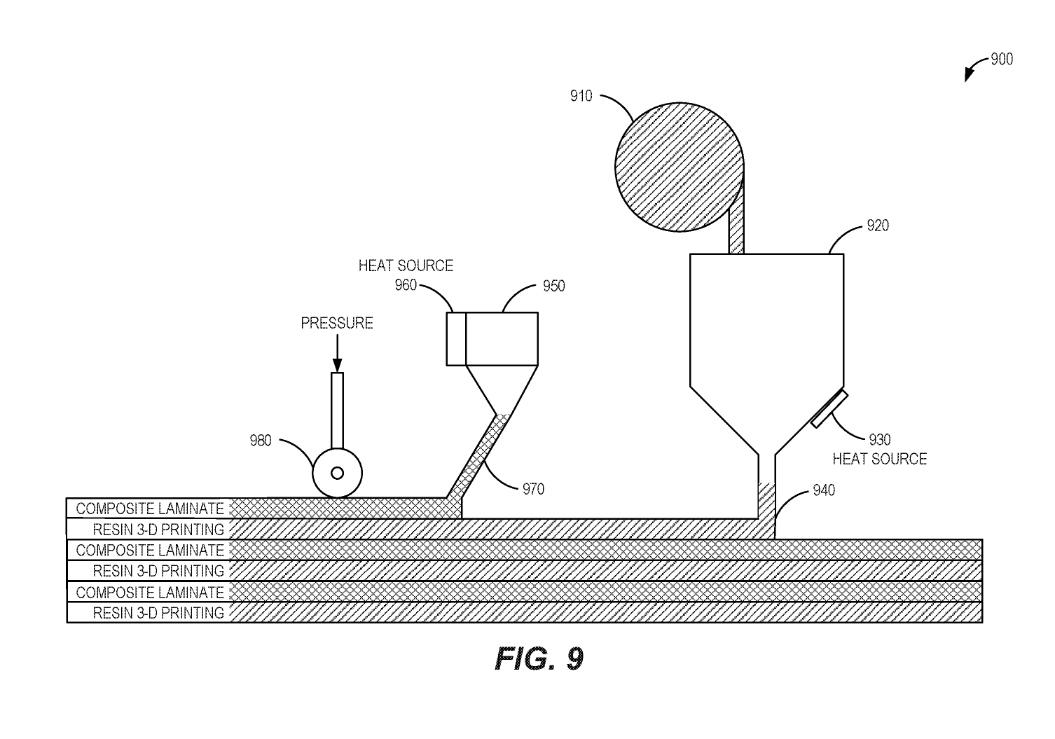

FIG. 9 is a block diagram of planar Hybrid Additive Manufacturing 900. A resin may be supplied from a resin basin 910 into a 3-D printing head 920. The printing head 920 may include a resin heat source 930 to melt the resin (e.g., resin in composite laminate) and print a 3-D printed layer 940. The heat source 930 may be a laser, IR emitter, resistive heat source, or any other type of heat source. The ATP or composite laminate layer may be provided by an ATP/laminate placement device 950. The placement device 950 may also have a heat source 960 to melt the ATP/laminate resin or to melt resin that was previously printed. Placement device 950 may apply an ATP/laminate layer 970. The composite laminate layer may include strips of tapes, pre-trimmed laminate, or laminate that is trimmed after printing. The printing head 920 or the placement device 950 may include a chopping mechanism for use on the 3-D printed layer 940 or on the ATP/laminate layer 970. The printing head 920 and the placement device 950 may be separate device mounted on a single gantry, such as a gantry that includes an extruder and an ATP device. The printing head 920 and the placement device 950 may be combined into a single combination print head. The combination print head may select, combine, and print two or more types of fibers or resins. For example, a chopped carbon-fiber may be combined with a first resin to print 3-D printed layer 940, and a long-fiber may be combined with an ATP resin to form ATP/laminate layer 970. When using multiple fibers or resins, the types of fibers and resins could be selected to be compatible with each other or with the printing head 920 and the placement device 950. A pressure application device 980 may apply pressure to either or both 3-D printed layers 940 and ATP/laminate layers 970. The pressure application device 980 may be cylindrical, spherical, or planar, and may be used to consolidate layers, flatten individual layer surfaces, reduce or remove wrinkles from placed tape, or provide consistency in printed layer thickness.

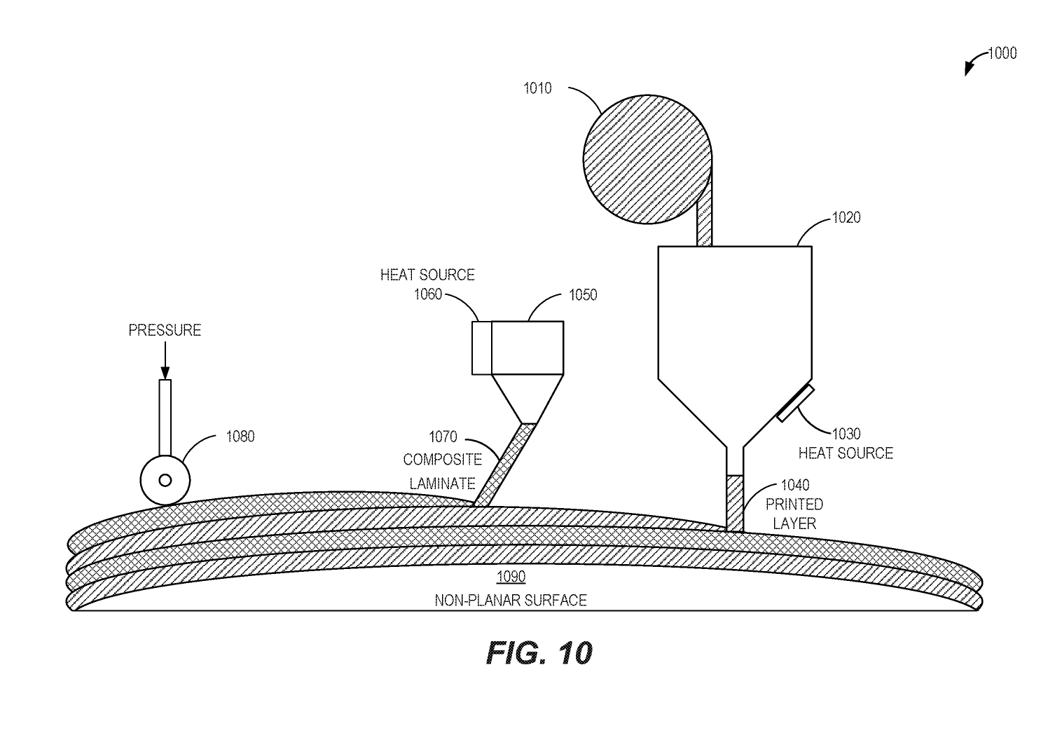

FIG. 10 is a block diagram of non-planar Hybrid Additive Manufacturing 1000. A resin may be supplied from a resin basin 1010 into a 3-D printing head 1020. The printing head 1020 may include a resin heat source 1030 to melt the resin and print a non-planar 3-D printed layer 1040. The ATP or composite laminate layer may be provided by an ATP/laminate placement device 1050, which may use heat source 1060 to melt the ATP/laminate resin. Placement device 1050 may apply a non-planar ATP/laminate layer 1070. A pressure application device 1080 may apply pressure to either or both 3-D printed layers 1040 and ATP/laminate layers 1070. The non-planar 3-D printed layer 1040 may be formed using a moveable printing head 1020, using a moveable ATP/laminate placement device 1050, using a moveable non-planar surface 1090, or using a combination of stationary and moveable components.

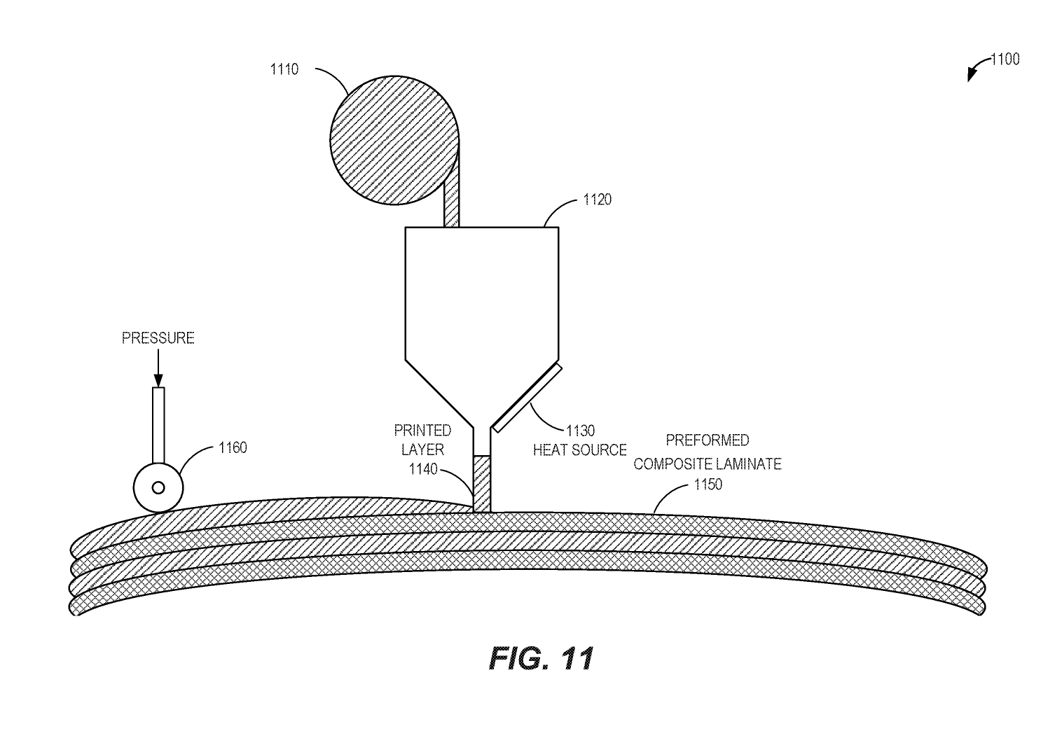

FIG. 11 is a block diagram of non-planar Hybrid Additive Manufacturing with pre-formed laminates 1100. The use of pre-formed laminates is similar to the non-planar printing shown in FIG. 10, using a resin basin 1110, a 3-D printing head 1120, and a resin heat source 1130 to melt the resin and print a non-planar 3-D printed layer 1140. In contrast with ATP/laminate printing described above, the printed layer 1140 is printed directly on a preformed composite laminate 1150. The composite laminate 1150 may be printed or injection-molded. A pressure application device 1160 may apply pressure to either or both the printed layer 1140 and the preformed composite laminate 1150.

The preformed composite laminate 1150 may be fabricated through various methods. One method of composite material fabrication includes laying multiple dry composite layers (e.g., composite piles, prepreg piles) onto a mold tool to form a laminate stack (e.g., a layup). Resin may be applied to the laminate stack after the full laminate stack is laid, or resin may be applied to each composite layer and the full laminate stack may be compacted (e.g., debulked).

In contrast to existing injection molding techniques, Hybrid Additive Manufacturing with pre-formed laminates 1100 enables the use of multiple layers of composite or laminate materials. For example, various characteristics of the printed layer 1140 and the preformed composite laminate 1150 may be selected to produce a desired printed object, such as size, structure, or other characteristics.

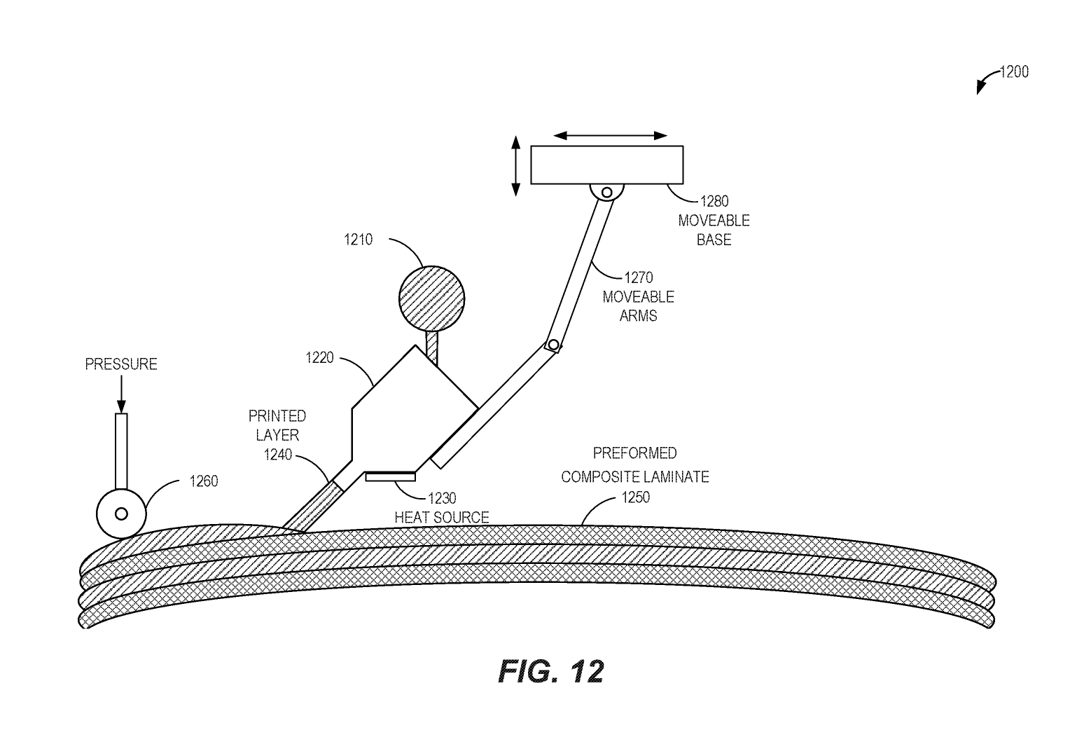

FIG. 12 is a block diagram of non-planar moveable Hybrid Additive Manufacturing with pre-formed laminates 1200. The use of moveable 3-D printing 1200 is similar to the non-planar printing shown in FIG. 11, using a resin basin 1210, a 3-D printing head 1220, a resin heat source 1230, and a pressure application device 1260 to print a non-planar 3-D printed layer 1240 on a preformed composite laminate 1250. Composite laminate 1250 may be pre-formed to the required shape. In contrast with ATP/laminate printing described above, the moveable 3-D printing 1200 uses one or more moveable arms 1270 or moveable base 1280. The use of moveable arms 1270 or moveable base 1280 enables printing on non-planar surfaces, and enables the printing of complex shapes. For example, 3-D printing on simple preformed composite laminate 1250 may be accomplished using non-planar tool paths, whereas 3-D printing on complex preformed composite laminate 1250 may be accomplished using moveable arms 1270 or moveable base 1280.

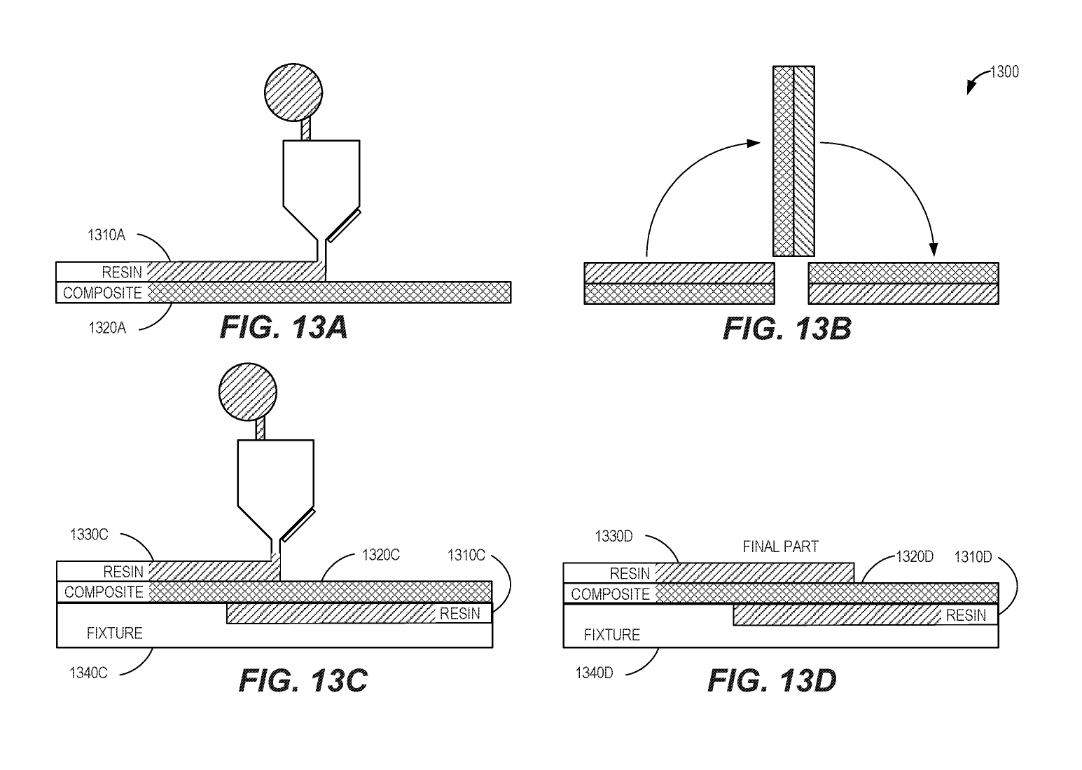

FIGS. 13A-13D are block diagrams of Hybrid Additive Manufacturing using fixtures 1300. In some implementations, a 3-D printed object may include a single layer of laminate that requires adhesion on both sides. FIG. 13A shows printing a first resin layer 1310A on a first side of a composite laminate 1320A to form a first part stage. The first part stage may be rotated as shown in FIG. 13B. As shown in FIG. 13C, the first part stage may be moved to a desired position on or within a fixture 1340C. Alternatively, the printing fixture or Hybrid Additive Manufacturing print head may be rotated around the first part stage. FIG. 13C shows printing of a second layer of resin 1330C on the second side of the composite layer 1320C.

A similar process may be used for printing a leveling layer on a fixture. As shown in FIG. 13D, fixture 1340D may have an irregular surface, and resin layer 1310D may serve as a leveling layer on fixture 1340D. As shown in FIG. 13D, resin layer 1330D also includes an irregular surface, and a leveling layer may be printed on resin layer 1330D. Another example of this may be the use of one or more preformed composite laminate layers with irregular surfaces. For example, a first level layer may be printed, a preformed composite laminate layer with irregular surfaces may be deposited on top of the first layer, and a leveling layer may be printed on the irregular surfaces to create a level surface. A leveling layer may be useful in providing a level surface for subsequent layers, such as when combining the printed layers with a flat surface on a preformed structure. A leveling layer may be used with any combination of a fixture layer, resin layer, composite layer, or other types of layers.

The steps shown in FIGS. 13A-13C may be performed on a single machine, or the part may be moved throughout various machine or stations for each of the steps, such as moved using robotic arms. The final printed part is shown in FIG. 13D, and includes one composite layer 1320 with printed resin layers 1310D and 1330D. While FIGS. 13A-13D show printing a planar object, the printing may be planar or non-planar, and tapes or laminates may be used.

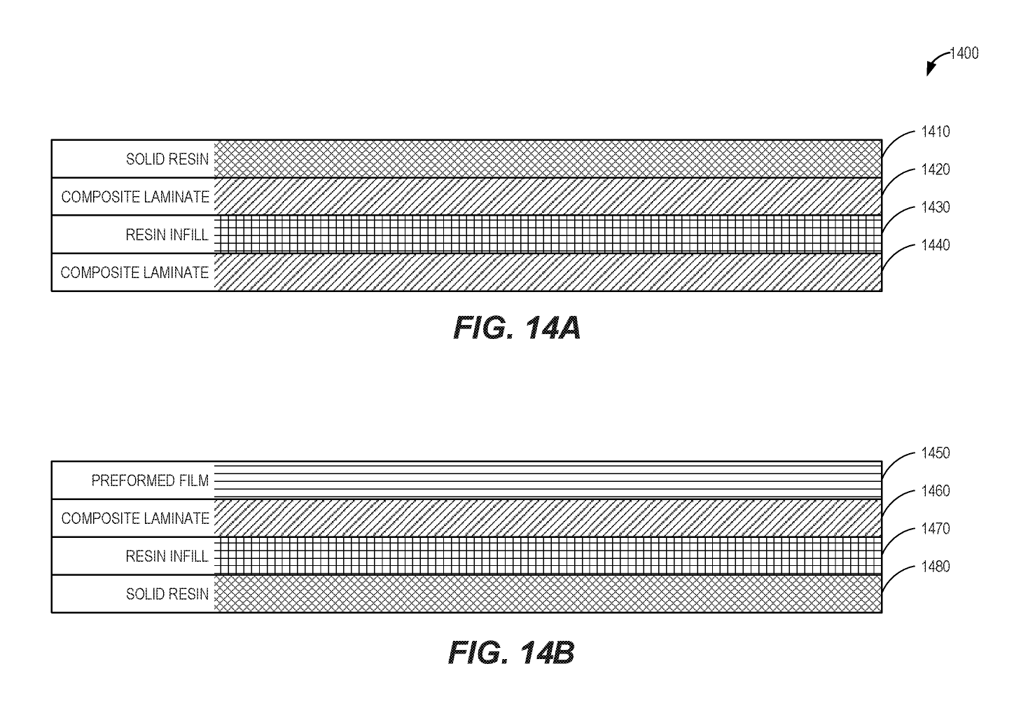

FIGS. 14A-14B are block diagrams of 3-D printing with ATP/laminates 1400. Various interior or exterior materials may be used to provide desired characteristics. In contrast with the alternating layers of resin and composite laminate shown in FIGS. 9-13, FIG. 14A shows a resin infill 1430 printed between a first composite laminate 1440 and a second composite laminate 1420. The resin infill 1430 may be of a different density or structure than a solid resin layer 1410, such as using a honeycomb structure to reduce weight. As shown in FIG. 14B, a preformed film 1450 may be combined with a composite laminate 1460, resin infill 1470, and solid resin 1480. The preformed film 1450 may be used for a surface finish, such as giving the appearance of chromed metal. The preformed film 1450 may be used to provide a surface with specific characteristics, such as printing a flame-resistant outer layer. Other combinations of resin structures, preformed laminates, external preformed films, or other materials to form a printed part with the desired structural characteristics. For example, a laminate may be printed in a region of high tensile strength. The combinations may include multiple layers of a single material, multiple layers of a various materials, or combinations thereof.

### VARIOUS NOTES & EXAMPLES

In the event of inconsistent usages between this document and any documents so incorporated by reference, the usage in this document controls.

Method examples described herein can be machine or computer-implemented at least in part. For example, a machine or computer may identify or implement various 3-D printing regions and selecting a material, printing direction, or printed cross-section shape. Some examples can include a tangible, computer-readable medium or machine-readable medium encoded with instructions that are operable to configure an electronic device to perform methods as described in the above examples. An implementation of such methods can include code, such as microcode, assembly language code, a higher-level language code, or the like. Such code can include computer-readable instructions for performing various methods. The code may form portions of computer program products. Further, in some examples, the code can be tangibly stored on one or more volatile, non-transitory, or non-volatile tangible computer-readable media, such as during execution or at other times. Examples of these tangible computer-readable media can include, but are not limited to, hard disks, removable magnetic disks, removable optical disks (e.g., compact disks and digital video disks), magnetic cassettes, memory cards or sticks, random access memories (RAMs), read only memories (ROMs), and the like.

Example 1 is a method for optimizing a three-dimensional object printing model, the method comprising: receiving a three-dimensional (3-D) digital model; identifying a plurality of stress regions based on the digital model; identifying a plurality of 3-D printing regions based on the identified plurality of stress regions; and storing the plurality of 3-D printing regions in an optimized 3-D object printing model.

In Example 2, the subject matter of Example 1 optionally further includes receiving a defined design architecture constraint.

In Example 3, the subject matter of Example 2 optionally includes wherein the defined design architecture constraint includes at least one of a digital model deformation constraint and a digital model deflection constraint.

In Example 4, the subject matter of any one or more of Examples 2-3 optionally includes wherein the defined design architecture constraint includes a material distribution optimization, the material distribution optimization including at least one of a reduced printed object weight constraint and an increased printed object stiffness constraint.

In Example 5, the subject matter of any one or more of Examples 2-4 optionally includes wherein: identifying the plurality of stress regions is further based on the defined design architecture constraint; and identifying the plurality of 3-D printing regions is further based on the defined design architecture constraint.

In Example 6, the subject matter of any one or more of Examples 1-5 optionally includes wherein identifying the plurality of stress regions includes identifying a first stress region and identifying a second stress region within the digital model.

In Example 7, the subject matter of Example 6 optionally includes wherein the first stress region is associated with a higher stress than the second stress region.

In Example 8, the subject matter of any one or more of Examples 6-7 optionally includes wherein: the first stress region is associated with a compression region; and the second stress region is associated with a tension region.

In Example 9, the subject matter of any one or more of Examples 6-8 optionally includes wherein identifying the plurality of 3-D printing regions includes identifying a first printing region and identifying a second printing region within the digital model, the identification of the first and second printing regions based on the identification of the first and second stress regions.

In Example 10, the subject matter of Example 9 optionally includes wherein: identifying the first printing region includes determining a first printing region location and determining a first 3-D printing characteristic; and identifying the second printing region includes determining a second printing region location and determining a second 3-D printing characteristic, the first characteristic being different from the second characteristic.

In Example 11, the subject matter of Example 10 optionally includes wherein determining the first 3-D printing characteristic includes determining a tubular compression-resistant structure.

In Example 12, the subject matter of Example 11 optionally further includes printing the tubular compression-resistant structure in a direction of minimum principal stresses.

In Example 13, the subject matter of any one or more of Examples 11-12 optionally includes wherein the tubular compression-resistant structure includes a honeycomb structure.

In Example 14, the subject matter of any one or more of Examples 10-13 optionally further including printing a transverse separator between the first printing region and the second printing region.

In Example 15, the subject matter of Example 14 optionally includes wherein the transverse separator includes a substantially planar surface.

In Example 16, the subject matter of any one or more of Examples 10-15 optionally includes wherein determining the second 3-D printing characteristic includes determining a tension-resistant material fiber content.

In Example 17, the subject matter of any one or more of Examples 10-16 optionally includes wherein: determining the first 3-D printing characteristic includes determining a first 3-D printing material; and determining the second 3-D printing characteristic includes determining a second 3-D printing material.

In Example 18, the subject matter of Example 17 optionally further includes determining a first 3-D printing bead route based on an expected contraction associated with the first 3-D printing material.

In Example 19, the subject matter of any one or more of Examples 17-18 optionally includes wherein the first material includes a 3-D printing deposit material.

In Example 20, the subject matter of Example 19 optionally includes wherein the 3-D printing deposit material includes at least one of a filament material, a pellet material, a powder material, a liquid material, and a paste material.

In Example 21, the subject matter of any one or more of Examples 17-20 optionally includes wherein the second material includes a 3-D printing reinforcement material.

In Example 22, the subject matter of Example 21 optionally further including: forming the first printing region from the printing deposit material; and forming the second printing region by applying the reinforcement material to the first printing region, the first printing region and the second printing region combining to form an optimized 3-D printed object.

In Example 23, the subject matter of Example 22 optionally further includes applying pressure to the second printing region to adhere the second printing region to the first printing region.

In Example 24, the subject matter of any one or more of Examples 22-23 optionally further including applying heat to the second printing region to adhere the second printing region to the first printing region.

In Example 25, the subject matter of any one or more of Examples 21-24 optionally includes wherein the reinforcement material includes a fiber-reinforced material.

In Example 26, the subject matter of Example 25 optionally includes wherein the fiber-reinforced material includes a chopped fiber material.

In Example 27, the subject matter of Example 26 optionally includes wherein the chopped fiber material includes a fiber tape.

In Example 28, the subject matter of Example 27 optionally includes wherein the fiber tape is configured for Automatic Tape Placement (ATP).

In Example 29, the subject matter of any one or more of Examples 27-28 optionally includes wherein the fiber tape includes a unidirectional fiber tape.

In Example 30, the subject matter of any one or more of Examples 27-29 optionally includes wherein the fiber tape includes an adhesive fiber tape.

In Example 31, the subject matter of any one or more of Examples 26-30 optionally includes wherein the chopped fiber material includes at least one of a woven fabric, a nonwoven fabric, and a fiber-reinforced preform.

In Example 32, the subject matter of any one or more of Examples 26-31 optionally includes wherein the chopped fiber material includes one or more of inorganic fibers, organic fibers, and metallic fibers.

In Example 33, the subject matter of any one or more of Examples 21-32 optionally includes wherein the reinforcement material includes a composite preform.

In Example 34, the subject matter of any one or more of Examples 21-33 optionally includes wherein the reinforcement material includes a composite laminate.

In Example 35, the subject matter of any one or more of Examples 10-34 optionally further including: printing the first printing region based on the first 3-D printing characteristic; and printing the second printing region on the first printing region based on the second 3-D printing characteristic, the first printing region and the second printing region combining to form an optimized 3-D printed object.

In Example 36, the subject matter of any one or more of Examples 10-35 optionally includes wherein the first 3-D printing characteristic and the second 3-D printing characteristic are selected to provide a gradually varying structure within the optimized 3-D object printing model.

In Example 37, the subject matter of any one or more of Examples 17-36 optionally includes wherein: determining the first 3-D printing material is based on a first elastic modulus associated with the first stress region; and determining the second 3-D printing material is based on a second elastic modulus associated with the second stress region.

In Example 38, the subject matter of any one or more of Examples 17-37 optionally further including: determining the first 3-D printing material is based on a first yield strength associated with the first stress region; and determining the second 3-D printing material is based on a second yield strength associated with the second stress region.

In Example 39, the subject matter of any one or more of Examples 17-38 optionally includes wherein: determining the first 3-D printing material includes determining a first composite material fiber content; and determining the second 3-D printing material includes determining a second composite material fiber content.

In Example 40, the subject matter of any one or more of Examples 17-39 optionally includes wherein: determining the first 3-D printing material is based on a first material density; and determining the second 3-D printing material is based on a second material density, first material density being more dense than the second material density.

In Example 41, the subject matter of any one or more of Examples 10-40 optionally includes wherein: determining the first 3-D printing characteristic includes identifying a first 3-D printing infill structure; and determining the second 3-D printing characteristic includes identifying a second 3-D printing infill structure.

In Example 42, the subject matter of any one or more of Examples 10-41 optionally includes wherein determining the second 3-D printing characteristic includes identifying a 3-D printing external reinforcement structure.

In Example 43, the subject matter of any one or more of Examples 41-42 optionally includes wherein: the first infill structure includes a first infill structure density; and the second infill structure includes a second infill structure density, the first infill structure density being greater than the second infill structure density.

In Example 44, the subject matter of Example 43 optionally includes wherein the first infill structure density is configured to alter a structure strength relative to the digital model.

In Example 45, the subject matter of any one or more of Examples 43-44 optionally includes wherein the first infill structure density is configured to alter a structure stiffness relative to the digital model.

In Example 46, the subject matter of any one or more of Examples 43-45 optionally includes wherein the second infill structure density is configured to reduce weight relative to the digital model.

In Example 47, the subject matter of any one or more of Examples 41-46 optionally includes wherein: the first infill structure includes a first linear infill printing pattern; and the first infill structure includes a second linear infill printing pattern.

In Example 48, the subject matter of Example 47 optionally includes wherein: the first linear infill printing pattern includes a lateral infill printing pattern; and the second linear infill printing pattern includes a longitudinal infill printing pattern, the lateral infill printing pattern being transverse to the longitudinal infill printing pattern.

In Example 49, the subject matter of any one or more of Examples 41-48 optionally includes wherein the first infill structure and the second infill structure include a shaped infill printing pattern.

In Example 50, the subject matter of Example 49 optionally includes wherein the shaped infill printing pattern includes a honeycomb structure.

In Example 51, the subject matter of any one or more of Examples 41-50 optionally includes wherein: the first printing region includes a first subregion, the first subregion including a fine lateral infill printing pattern; the first printing region further includes a second subregion, the second subregion including a coarse lateral infill printing pattern; the second printing region includes a third subregion, the third subregion including a fine longitudinal infill printing pattern; and the second printing region further includes a fourth subregion, the fourth subregion including a coarse longitudinal infill printing pattern.

In Example 52, the subject matter of any one or more of Examples 2-51 optionally further including: identifying an object outer surface shape based on the digital model; identifying an object surface thickness based on the defined design architecture constraint; and wherein identifying the plurality of 3-D printing regions is based on the object outer surface shape and the object surface thickness.

Example 53 is a system for optimizing a three-dimensional (3-D) object printing model, the system including: a memory; and a processor configured to: receive a three-dimensional (3-D) digital model; identify a plurality of stress regions based on the digital model; identify a plurality of 3-D printing regions based on the identified plurality of stress regions; and store the plurality of 3-D printing regions in an optimized 3-D object printing model on the memory; and a 3-D printing mechanism configured to print the plurality of 3-D printing regions.

In Example 54, the subject matter of Example 53 optionally includes the 3-D printing mechanism including: a material deposition device to form a deposited layer; and a reinforcement placement device configured to apply a reinforcement material to the deposited layer.

In Example 55, the subject matter of Example 54 optionally includes wherein the material deposition device includes at least one of a melt deposition head and a powder sintering head.

In Example 56, the subject matter of any one or more of Examples 54-55 optionally includes wherein the material deposition device forms the deposited layer using at least one of fused deposition modeling (FDM), selective laser sintering (SLS), stereolithography (SLA), large format additive manufacturing, and freeform additive manufacturing.

In Example 57, the subject matter of any one or more of Examples 53-56 optionally further including the 3-D printing mechanism including at least one of a palette sequencing filament feeding system, a diamond hot head multi nozzle system, and a multi-nozzle system.

In Example 58, the subject matter of any one or more of Examples 53-57 optionally includes wherein the 3-D printing mechanism is mounted on at least one of a gantry and a robotic arm.

In Example 59, the subject matter of any one or more of Examples 53-58 optionally further including the processor further configured to receive a defined design architecture constraint.

In Example 60, the subject matter of Example 59 optionally includes wherein the defined design architecture constraint includes at least one of a digital model deformation constraint and a digital model deflection constraint.

In Example 61, the subject matter of any one or more of Examples 59-60 optionally includes wherein the defined design architecture constraint includes a material distribution optimization, the material distribution optimization including at least one of a reduced printed object weight constraint and an increased printed object stiffness constraint.

In Example 62, the subject matter of any one or more of Examples 59-61 optionally includes wherein: identifying the plurality of stress regions is further based on the defined design architecture constraint; and identifying the plurality of 3-D printing regions is further based on the defined design architecture constraint.

In Example 63, the subject matter of any one or more of Examples 53-62 optionally includes wherein identifying the plurality of stress regions includes identifying a first stress region and identifying a second stress region within the digital model.

In Example 64, the subject matter of Example 63 optionally includes wherein the first stress region is associated with a higher stress than the second stress region.

In Example 65, the subject matter of any one or more of Examples 63-64 optionally includes wherein: the first stress region is associated with a compression region; and the second stress region is associated with a tension region.

In Example 66, the subject matter of any one or more of Examples 63-65 optionally includes wherein identifying the plurality of 3-D printing regions includes identifying a first printing region and identifying a second printing region within the digital model, the identification of the first and second printing regions based on the identification of the first and second stress regions.

In Example 67, the subject matter of Example 66 optionally includes wherein: identifying the first printing region includes determining a first printing region location and determining a first 3-D printing characteristic; and identifying the second printing region includes determining a second printing region location and determining a second 3-D printing characteristic, the first characteristic being different from the second characteristic.

In Example 68, the subject matter of Example 67 optionally includes wherein determining the first 3-D printing characteristic includes determining a tubular compression-resistant structure.

In Example 69, the subject matter of Example 68 optionally includes the 3-D printing mechanism further configured to print the tubular compression-resistant structure in a direction of minimum principal stresses.

In Example 70, the subject matter of any one or more of Examples 68-69 optionally includes wherein the tubular compression-resistant structure includes a honeycomb structure.

In Example 71, the subject matter of any one or more of Examples 67-70 optionally further including the 3-D printing mechanism further configured to print a transverse separator between the first printing region and the second printing region.

In Example 72, the subject matter of Example 71 optionally includes wherein the transverse separator includes a substantially planar surface.

In Example 73, the subject matter of any one or more of Examples 67-72 optionally includes wherein determining the second 3-D printing characteristic includes determining a tension-resistant material fiber content.

In Example 74, the subject matter of any one or more of Examples 67-73 optionally includes wherein: determining the first 3-D printing characteristic includes determining a first 3-D printing material; and determining the second 3-D printing characteristic includes determining a second 3-D printing material.

In Example 75, the subject matter of Example 74 optionally includes the processor further configured to determine a first 3-D printing bead route based on an expected contraction associated with the first 3-D printing material.

In Example 76, the subject matter of any one or more of Examples 74-75 optionally includes wherein the first material includes a 3-D printing deposit material.

In Example 77, the subject matter of Example 76 optionally includes wherein the 3-D printing deposit material includes at least one of a filament material, a pellet material, a powder material, a liquid material, and a paste material.

In Example 78, the subject matter of any one or more of Examples 74-77 optionally includes wherein the second material includes a 3-D printing reinforcement material.

In Example 79, the subject matter of Example 78 optionally includes the 3-D printing mechanism further configured to: form the first printing region from the printing deposit material; and form the second printing region by applying the reinforcement material to the first printing region, the first printing region and the second printing region combining to form an optimized 3-D printed object.

In Example 80, the subject matter of Example 79 optionally includes the 3-D printing mechanism further configured to apply pressure to the second printing region to adhere the second printing region to the first printing region.

In Example 81, the subject matter of any one or more of Examples 79-80 optionally further including the 3-D printing mechanism further configured to apply heat to the second printing region to adhere the second printing region to the first printing region.

In Example 82, the subject matter of any one or more of Examples 78-81 optionally includes wherein the reinforcement material includes a fiber-reinforced material.

In Example 83, the subject matter of Example 82 optionally includes wherein the fiber-reinforced material includes a chopped fiber material.

In Example 84, the subject matter of Example 83 optionally includes wherein the chopped fiber material includes a fiber tape.

In Example 85, the subject matter of Example 84 optionally includes wherein the fiber tape is configured for Automatic Tape Placement (ATP).

In Example 86, the subject matter of any one or more of Examples 84-85 optionally includes wherein the fiber tape includes a unidirectional fiber tape.

In Example 87, the subject matter of any one or more of Examples 84-86 optionally includes wherein the fiber tape includes an adhesive fiber tape.

In Example 88, the subject matter of any one or more of Examples 83-87 optionally includes wherein the chopped fiber material includes at least one of a woven fabric, a nonwoven fabric, and a fiber-reinforced preform.

In Example 89, the subject matter of any one or more of Examples 83-88 optionally includes wherein the chopped fiber material includes one or more of inorganic fibers, organic fibers, and metallic fibers.

In Example 90, the subject matter of any one or more of Examples 78-89 optionally includes wherein the reinforcement material includes a composite preform.

In Example 91, the subject matter of any one or more of Examples 78-90 optionally includes wherein the reinforcement material includes a composite laminate.

In Example 92, the subject matter of any one or more of Examples 67-91 optionally further including the 3-D printing mechanism further configured to: print the first printing region based on the first 3-D printing characteristic; and print the second printing region on the first printing region based on the second 3-D printing characteristic, the first printing region and the second printing region combining to form an optimized 3-D printed object.

In Example 93, the subject matter of any one or more of Examples 67-92 optionally includes wherein the first 3-D printing characteristic and the second 3-D printing characteristic are selected to provide a gradually varying structure within the optimized 3-D object printing model.

In Example 94, the subject matter of any one or more of Examples 74-93 optionally includes wherein: determining the first 3-D printing material is based on a first elastic modulus associated with the first stress region; and determining the second 3-D printing material is based on a second elastic modulus associated with the second stress region.

In Example 95, the subject matter of any one or more of Examples 74-94 optionally further including the processor further configured to: determine the first 3-D printing material is based on a first yield strength associated with the first stress region; and determine the second 3-D printing material is based on a second yield strength associated with the second stress region.

In Example 96, the subject matter of any one or more of Examples 74-95 optionally includes wherein: determining the first 3-D printing material includes determining a first composite material fiber content; and determining the second 3-D printing material includes determining a second composite material fiber content.

In Example 97, the subject matter of any one or more of Examples 74-96 optionally includes wherein: determining the first 3-D printing material is based on a first material density; and determining the second 3-D printing material is based on a second material density, first material density being more dense than the second material density.

In Example 98, the subject matter of any one or more of Examples 67-97 optionally includes wherein: determining the first 3-D printing characteristic includes identifying a first 3-D printing infill structure; and determining the second 3-D printing characteristic includes identifying a second 3-D printing infill structure.

In Example 99, the subject matter of any one or more of Examples 67-98 optionally includes wherein determining the second 3-D printing characteristic includes identifying a 3-D printing external reinforcement structure.

In Example 100, the subject matter of any one or more of Examples 98-99 optionally includes wherein: the first infill structure includes a first infill structure density; and the second infill structure includes a second infill structure density, the first infill structure density being greater than the second infill structure density.

In Example 101, the subject matter of Example 100 optionally includes wherein the first infill structure density is configured to alter a structure strength relative to the digital model.

In Example 102, the subject matter of any one or more of Examples 100-101 optionally includes wherein the first infill structure density is configured to alter a structure stiffness relative to the digital model.

In Example 103, the subject matter of any one or more of Examples 100-102 optionally includes wherein the second infill structure density is configured to reduce weight relative to the digital model.

In Example 104, the subject matter of any one or more of Examples 98-103 optionally includes wherein: the first infill structure includes a first linear infill printing pattern; and the first infill structure includes a second linear infill printing pattern.

In Example 105, the subject matter of Example 104 optionally includes wherein: the first linear infill printing pattern includes a lateral infill printing pattern; and the second linear infill printing pattern includes a longitudinal infill printing pattern, the lateral infill printing pattern being transverse to the longitudinal infill printing pattern.

In Example 106, the subject matter of any one or more of Examples 98-105 optionally includes wherein the first infill structure and the second infill structure include a shaped infill printing pattern.

In Example 107, the subject matter of Example 106 optionally includes wherein the shaped infill printing pattern includes a honeycomb structure.

In Example 108, the subject matter of any one or more of Examples 98-107 optionally includes wherein: the first printing region includes a first subregion, the first subregion including a fine lateral infill printing pattern; the first printing region further includes a second subregion, the second subregion including a coarse lateral infill printing pattern; the second printing region includes a third subregion, the third subregion including a fine longitudinal infill printing pattern; and the second printing region further includes a fourth subregion, the fourth subregion including a coarse longitudinal infill printing pattern.

In Example 109, the subject matter of any one or more of Examples 59-108 optionally further including the processor further configured to: identify an object outer surface shape based on the digital model; identify an object surface thickness based on the defined design architecture constraint; and wherein identifying the plurality of 3-D printing regions is based on the object outer surface shape and the object surface thickness.

Example 110 is at least one machine-readable medium including instructions that, when executed, cause the machine to perform operations for optimizing a three-dimensional object printing model, the operations comprising: receiving a three-dimensional (3-D) digital model; identifying a plurality of stress regions based on the digital model; identifying a plurality of 3-D printing regions based on the identified plurality of stress regions; and storing the plurality of 3-D printing regions in an optimized 3-D object printing model.

In Example 111, the subject matter of Example 110 optionally further including receiving a defined design architecture constraint.

In Example 112, the subject matter of Example 111 optionally further including wherein the defined design architecture constraint includes at least one of a digital model deformation constraint and a digital model deflection constraint.

In Example 113, the subject matter of any one or more of Examples 111-112 optionally further including wherein the defined design architecture constraint includes a material distribution optimization, the material distribution optimization including at least one of a reduced printed object weight constraint and an increased printed object stiffness constraint.

In Example 114, the subject matter of any one or more of Examples 111-113 optionally further including wherein: identifying the plurality of stress regions is further based on the defined design architecture constraint; and identifying the plurality of 3-D printing regions is further based on the defined design architecture constraint.

In Example 115, the subject matter of any one or more of Examples 110-114 optionally further including wherein identifying the plurality of stress regions includes identifying a first stress region and identifying a second stress region within the digital model.

In Example 116, the subject matter of Example 115 optionally further including wherein the first stress region is associated with a higher stress than the second stress region.

In Example 117, the subject matter of any one or more of Examples 115-116 optionally further including wherein: the first stress region is associated with a compression region; and the second stress region is associated with a tension region.

In Example 118, the subject matter of any one or more of Examples 115-117 optionally further including wherein identifying the plurality of 3-D printing regions includes identifying a first printing region and identifying a second printing region within the digital model, the identification of the first and second printing regions based on the identification of the first and second stress regions.

In Example 119, the subject matter of Example 118 optionally further including wherein: identifying the first printing region includes determining a first printing region location and determining a first 3-D printing characteristic; and identifying the second printing region includes determining a second printing region location and determining a second 3-D printing characteristic, the first characteristic being different from the second characteristic.

In Example 120, the subject matter of Example 119 optionally further including wherein determining the first 3-D printing characteristic includes determining a tubular compression-resistant structure.

In Example 121, the subject matter of Example 120 optionally further including printing the tubular compression-resistant structure in a direction of minimum principal stresses.

In Example 122, the subject matter of any one or more of Examples 120-121 optionally further including wherein the tubular compression-resistant structure includes a honeycomb structure.

In Example 123, the subject matter of any one or more of Examples 119-122 optionally further including printing a transverse separator between the first printing region and the second printing region.

In Example 124, the subject matter of Example 123 optionally further including wherein the transverse separator includes a substantially planar surface.

In Example 125, the subject matter of any one or more of Examples 119-124 optionally further including wherein determining the second 3-D printing characteristic includes determining a tension-resistant material fiber content.

In Example 126, the subject matter of any one or more of Examples 119-125 optionally further including wherein: determining the first 3-D printing characteristic includes determining a first 3-D printing material; and determining the second 3-D printing characteristic includes determining a second 3-D printing material.

In Example 127, the subject matter of Example 126 optionally further including determining a first 3-D printing bead route based on an expected contraction associated with the first 3-D printing material.

In Example 128, the subject matter of any one or more of Examples 126-127 optionally further including wherein the first material includes a 3-D printing deposit material.

In Example 129, the subject matter of Example 128 optionally further including wherein the 3-D printing deposit material includes at least one of a filament material, a pellet material, a powder material, a liquid material, and a paste material.

In Example 130, the subject matter of any one or more of Examples 128-129 optionally further including wherein the second material includes a 3-D printing reinforcement material.

In Example 131, the subject matter of Example 130 optionally further including: forming the first printing region from the printing deposit material; and forming the second printing region by applying the reinforcement material to the first printing region, the first printing region and the second printing region combining to form an optimized 3-D printed object.

In Example 132, the subject matter of Example 131 optionally further including applying pressure to the second printing region to adhere the second printing region to the first printing region.

In Example 133, the subject matter of any one or more of Examples 131-132 optionally further including applying heat to the second printing region to adhere the second printing region to the first printing region.

In Example 134, the subject matter of any one or more of Examples 130-133 optionally further including wherein the reinforcement material includes a fiber-reinforced material.

In Example 135, the subject matter of Example 134 optionally further including wherein the fiber-reinforced material includes a chopped fiber material.

In Example 136, the subject matter of Example 135 optionally further including wherein the chopped fiber material includes a fiber tape.

In Example 137, the subject matter of Example 136 optionally further including wherein the fiber tape is configured for Automatic Tape Placement (ATP).

In Example 138, the subject matter of any one or more of Examples 136-137 optionally further including wherein the fiber tape includes a unidirectional fiber tape.

In Example 139, the subject matter of any one or more of Examples 136-138 optionally further including wherein the fiber tape includes an adhesive fiber tape.

In Example 140, the subject matter of any one or more of Examples 135-139 optionally further including wherein the chopped fiber material includes at least one of a woven fabric, a nonwoven fabric, and a fiber-reinforced preform.

In Example 141, the subject matter of any one or more of Examples 135-140 optionally further including wherein the chopped fiber material includes one or more of inorganic fibers, organic fibers, and metallic fibers.

In Example 142, the subject matter of any one or more of Examples 130-141 optionally further including wherein the reinforcement material includes a composite preform.

In Example 143, the subject matter of any one or more of Examples 130-142 optionally further including wherein the reinforcement material includes a composite laminate.

In Example 144, the subject matter of any one or more of Examples 119-143 optionally further including: printing the first printing region based on the first 3-D printing characteristic; and printing the second printing region on the first printing region based on the second 3-D printing characteristic, the first printing region and the second printing region combining to form an optimized 3-D printed object.

In Example 145, the subject matter of any one or more of Examples 119-144 optionally further including wherein the first 3-D printing characteristic and the second 3-D printing characteristic are selected to provide a gradually varying structure within the optimized 3-D object printing model.

In Example 146, the subject matter of any one or more of Examples 126-145 optionally further including wherein: determining the first 3-D printing material is based on a first elastic modulus associated with the first stress region; and determining the second 3-D printing material is based on a second elastic modulus associated with the second stress region.

In Example 147, the subject matter of any one or more of Examples 126-146 optionally further including: determining the first 3-D printing material is based on a first yield strength associated with the first stress region; and determining the second 3-D printing material is based on a second yield strength associated with the second stress region.

In Example 148, the subject matter of any one or more of Examples 126-147 optionally further including wherein: determining the first 3-D printing material includes determining a first composite material fiber content; and determining the second 3-D printing material includes determining a second composite material fiber content.

In Example 149, the subject matter of any one or more of Examples 126-148 optionally further including wherein: determining the first 3-D printing material is based on a first material density; and determining the second 3-D printing material is based on a second material density, first material density being more dense than the second material density.

In Example 150, the subject matter of any one or more of Examples 119-149 optionally further including wherein: determining the first 3-D printing characteristic includes identifying a first 3-D printing infill structure; and determining the second 3-D printing characteristic includes identifying a second 3-D printing infill structure.

In Example 151, the subject matter of any one or more of Examples 119-150 optionally further including wherein determining the second 3-D printing characteristic includes identifying a 3-D printing external reinforcement structure.

In Example 152, the subject matter of any one or more of Examples 150-151 optionally further including wherein: the first infill structure includes a first infill structure density; and the second infill structure includes a second infill structure density, the first infill structure density being greater than the second infill structure density.

In Example 153, the subject matter of Example 152 optionally further including wherein the first infill structure density is configured to alter a structure strength relative to the digital model.

In Example 154, the subject matter of any one or more of Examples 152-153 optionally further including wherein the first infill structure density is configured to alter a structure stiffness relative to the digital model.

In Example 155, the subject matter of any one or more of Examples 152-154 optionally further including wherein the second infill structure density is configured to reduce weight relative to the digital model.

In Example 156, the subject matter of any one or more of Examples 150-155 optionally further including wherein: the first infill structure includes a first linear infill printing pattern; and the first infill structure includes a second linear infill printing pattern.

In Example 157, the subject matter of Example 156 optionally further including wherein: the first linear infill printing pattern includes a lateral infill printing pattern; and the second linear infill printing pattern includes a longitudinal infill printing pattern, the lateral infill printing pattern being transverse to the longitudinal infill printing pattern.

In Example 158, the subject matter of any one or more of Examples 150-157 optionally further including wherein the first infill structure and the second infill structure include a shaped infill printing pattern.

In Example 159, the subject matter of Example 158 optionally further including wherein the shaped infill printing pattern includes a honeycomb structure.

In Example 160, the subject matter of any one or more of Examples 150-159 optionally further including wherein: the first printing region includes a first subregion, the first subregion including a fine lateral infill printing pattern; the first printing region further includes a second subregion, the second subregion including a coarse lateral infill printing pattern; the second printing region includes a third subregion, the third subregion including a fine longitudinal infill printing pattern; and the second printing region further includes a fourth subregion, the fourth subregion including a coarse longitudinal infill printing pattern.

In Example 161, the subject matter of any one or more of Examples 111-160 optionally further including: identifying an object outer surface shape based on the digital model; identifying an object surface thickness based on the defined design architecture constraint; and wherein identifying the plurality of 3-D printing regions is based on the object outer surface shape and the object surface thickness.

The above description is intended to be illustrative, and not restrictive. For example, the above-described examples (or one or more aspects thereof) may be used in combination with each other. Other embodiments can be used, such as by one of ordinary skill in the art upon reviewing the above description. The Abstract is provided to comply with 37 C.F.R. § 1.72(b), to allow the reader to quickly ascertain the nature of the technical disclosure. It is submitted with the understanding that it will not be used to interpret or limit the scope or meaning of the claims. In addition, in the above Detailed Description, various features may be grouped together to streamline the disclosure. This should not be interpreted as intending that an unclaimed disclosed feature is essential to any claim. Rather, inventive subject matter may lie in less than all features of a particular disclosed embodiment. Thus, the following claims are hereby incorporated into the Detailed Description as examples or embodiments, with each claim standing on its own as a separate embodiment, and it is contemplated that such embodiments can be combined with each other in various combinations or permutations. The scope of the invention should be determined with reference to the appended claims, along with the full scope of equivalents to which such claims are entitled.

1. A method for optimizing a three-dimensional object printing model, the method comprising:
receiving a three-dimensional (3-D) digital model;
identifying a plurality of stress regions based on the digital model;
identifying a plurality of 3-D printing regions in which at least a fine fill, a coarse fill, and a coarser fill, each relative to each other, are to be used based on the identified plurality of stress regions to provide a gradually varying structure; and
storing the plurality of 3-D printing regions in an optimized 3-D object printing model.

2. The method of claim 1, further including receiving a defined design architecture constraint, the defined design architecture constraint including at least one of a digital model deformation constraint and a digital model deflection constraint.

3. The method of claim 2, wherein:
identifying a first stress region and identifying a second stress region within the digital model; and
identifying a first printing region and identifying a second printing region within the digital model, the identification of the first and second printing regions based on the identification of the first and second stress regions.

4. The method of claim 3, wherein:
identifying the first printing region includes determining a first printing region location and determining a first 3-D printing material; and
identifying the second printing region includes determining a second printing region location and determining a second 3-D printing material, the first material being different from the second material.

5. The method of claim 4, further including determining a first 3-D printing bead route based on an expected contraction associated with the first 3-D printing material.

6. The method of claim 4, wherein the second material includes a fiber-reinforced material.

7. The method of claim 6, wherein the fiber-reinforced material includes a chopped fiber material.

8. A system for optimizing a three-dimensional (3-D) object printing model, the system including:
a memory; and
a processor configured to:
receive a three-dimensional (3-D) digital model;
identify a plurality of stress regions based on the digital model;
identify a plurality of 3-D printing regions in which at least a fine fill, a coarse fill, and a coarser fill, each relative to each other, are to be used based on the identified plurality of stress regions to provide a gradually varying structure; and
store the plurality of 3-D printing regions in an optimized 3-D object printing model on the memory; and
a 3-D printing mechanism configured to print the plurality of 3-D printing regions.

9. The system of claim 8, the 3-D printing mechanism including:
a material deposition device to form a deposited layer; and
a reinforcement placement device configured to apply a reinforcement material to the deposited layer.

10. The system of claim 8, wherein the 3-D printing mechanism is mounted on at least one of a gantry and a robotic arm.

11. The system of claim 8, the processor further configured to receive a defined design architecture constraint.

12. The system of claim 11, wherein the defined design architecture constraint includes a material distribution optimization, the material distribution optimization including at least one of a reduced printed object weight constraint and an increased printed object stiffness constraint.

13. The system of claim 11, the processor further configured to:
identifying a first stress region and identifying a second stress region within the digital model; and
identifying a first printing region and identifying a second printing region within the digital model, the identification of the first and second printing regions based on the identification of the first and second stress regions.

14. The system of claim 13, the processor further configured to:
identifying the first printing region includes determining a first printing region location and determining a first 3-D printing material; and
identifying the second printing region includes determining a second printing region location and determining a second 3-D printing material, the first material being different from the second material.

15. The system of claim 14, wherein the second material includes a fiber-reinforced material.

16. The method of claim 1, wherein the 3-D printing regions in which the fine fill, the coarse fill, and the coarser fill are to be used correspond to a high stress region, a medium stress region, and a low stress region, respectively.

17. The method of claim 1, wherein the fine fill comprises at least one of a fine vertical fill and a fine horizontal fill, wherein the coarse fill comprises at least one of a coarse vertical fill and a coarse horizontal fill, and wherein the coarser fill comprises at least one of a coarser vertical fill and a coarser horizontal fill.

18. The system of claim 8, wherein the 3-D printing regions in which the fine fill, the coarse fill, and the coarser fill are to be used correspond to a high stress region, a medium stress region, and a low stress region, respectively.

19. The system of claim 8, wherein the fine fill comprises at least one of a fine vertical fill and a fine horizontal fill, wherein the coarse fill comprises at least one of a coarse vertical fill and a coarse horizontal fill, and wherein the coarser fill comprises at least one of a coarser vertical fill and a coarser horizontal fill.

20. The system of claim 8, wherein the 3-D printing mechanism comprises a compounding system.
